(19) United States
(12) Patent Application Publication
(10) Pub. No.: US 2011/0095874 A1
(43) Pub. Date: Apr. 28, 2011

(54) Remote switch to monitor and navigate an electronic device or system

(75) Inventor: Betty Bennett, Pacific Palisades, CA (US)

(73) Assignee: APOGEE ELECTRONICS CORPORATION, Santa Monica, CA (US)

(21) Appl. No.: 12/607,177

(22) Filed: Oct. 28, 2009

(51) Int. Cl. G08B 7/06; G08B 5/00

(52) U.S. Cl. 340/326; 340/332

(57) ABSTRACT

A remote switch monitors, navigates, and provides transport control to an electronic device or system, including computers or other digital systems. It includes: a switch with a visual indicator, transitionable between first and second states, or multiple states; a symbol on the visual indicator to identify the navigation function; and a communication interface to the electronic system. The device utilizes the communication interface to send a first message related to the navigation function to the electronic system in response to the user operating the switch; the device utilizes the communication interface to receive a second message related to the navigation status from the electronic system; and the visual indicator transitions between the first state and the second state to indicate the navigation status. The device may be used with the feet, freeing the hands to play an instrument such as a guitar, and provides tactile and visual feedback.

### BACKGROUND OF THE INVENTION

The present invention generally relates to electronic peripherals and more specifically to a remote switch to monitor and navigate an electronic device or system.

The recording of audio with software has progressed from the normal workflow of musician/performer, operator and assistant operator to that of a sole user, whereas the musician or performer carries out the task of multiple people, not relying on any other inputs from other users of the system to perform the tasks of manipulating the operation of an audio recorder and editor.

Existing products do not allow for a completely hands free environment to access the system. This, in turn complicates the workflow by requiring either an assistant to operate the system locally or remotely for the recording and playback functions, or for a single operator to adjust and adapt workflow to the limitations and constraints of present systems. Existing systems do not allow the user to access the interface functions of an audio, video or other local or remote streaming media workstation, or to perform other navigation of an electronic device, without the help of a second operator or an interruption of the recording of the musical performance.

There is therefore a need to allow the musician the ability to manipulate the software as much as possible without using a mouse, keyboard or other auxiliary input device, allowing the recording musician complete control over the functions of the software or hardware by manipulating only the foot controls, and providing tactile and visual feedback.

It would be desirable to have a device for controlling the transport or other navigation mechanisms of music-recording or other streaming data-recording equipment using the feet, or at least without using the hands, so that the hands of the musician is free to operate a musical instrument.

### SUMMARY OF THE INVENTION

In one aspect of the present invention, a device for a user to control a navigation function of an electronic system, the electronic system having a navigation status associated with the navigation function, includes: a switch adapted to be operated by the user; a visual indicator on the switch, transitionable between a first state and a second state; a symbol on the visual indicator to identify the navigation function; a communication interface to the electronic system; wherein the device utilizes the communication interface to send a first message related to the navigation function to the electronic system in response to the user operating the switch; the device utilizes the communication interface to receive a second message related to the navigation status from the electronic system; and the visual indicator transitions between the first state and the second state to indicate the navigation status.

In another aspect of the present invention, a device for a user to provide streaming data to an electronic system, the electronic system having a data setting associated with a color, includes: a switch adapted to be operated by the user; a visual indicator associated with the switch, to display a changeable color; a communication interface to the electronic system; an input interface to receive the streaming data; wherein the device receives the streaming data from the input interface and utilizes the communication interface to provide the streaming data to the electronic system; the device utilizes the communication interface to send a first message related to the data setting to the electronic system in response to the user operating the switch; the device utilizes the communication interface to receive a second message related to the data setting from the electronic system; and the visual indicator changes color to generally match the color with which the data setting associates

In yet another aspect of the present invention, a method for remotely monitoring and navigating an electronic system includes: providing a remote switch that indicates a navigation function and that transitions between a first state and a second state; operating the switch; in response to operating the switch, sending a first message related to the navigation function to the electronic system; receiving a second message related to a navigation status of the navigation function from the electronic system; and transitioning the switch (between) the first state, and the second state (or multiple states) to indicate the navigation status.

### BRIEF DESCRIPTION OF THE DRAWINGS

FIG. 1 depicts a top view of an embodiment of the present invention;

FIG. 2 depicts a perspective view of an embodiment of the present invention;

FIG. 3 depicts a back view of an embodiment of the present invention;

FIG. 4 depicts an embodiment of the present invention connected to a guitar, a pedal, a computer, and speakers; and

FIG. 5 depicts an embodiment of the present invention in use

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a foot operated control and interface for the remote operation of software to navigate or control transport of streaming media (including, but not limited to play/stop as well as other commands) with bi-directional tactile, visual and audible feedback to the user. The switch may (or may not) or provide a clicking sensation felt in the foot, such as when a button bottoms out, or the switch may provide an audible clicking or beeping sound when the control is depressed or released. A visual icon, graphic, symbol or other light monitors the status of the remote electronic device. The lights may be color-changeable lamps, and the color may be set by the device including, but not limited to a red-green-blue (RGB) or other code. The icon or symbol may be on a removable insert, and the switch retains and releases the insert to it can be changed to reflect a different navigation function. The switch is remote, because it is separable from the electronic device, such as by a cable or by wireless signals. The data may be “streaming” data, in the sense that the data represents music, video, telemetry, or other data that has sense of time-stamped frames sent in time order. The data could be created by a musical instrument such as a guitar, an audio/video recorder/editor, a telemetry-generating device, or the data could be otherwise generated or provided. A pre-amplifier may be included to support input from musical instruments, such as guitars. The software can reside on any device, whether designed into a host computer with software, a workstation, a still or video camera, a camera lens, a musical instrument or sound library, a stand-alone recording device, a mobile ‘smart’ phone, a computer terminal offering remote control of hosted storage (known as ‘cloud’ computing/storage), or any data recording device utilized by manipulating controls with one's foot. An embodiment of the present invention offers remote control of fixed or assigned (or ‘soft’) functions (for example, record, return to start, reverse, forward and play/stop) as well as remote control of ancillary functions utilizing the software. An embodiment of the invention takes the place of normal input functions provided by equipment such as a keyboard, mouse or any other type of input device that is not specifically designed for the purpose of recording or editing audio and transport functions.

An embodiment of the present invention includes a foot operated control and an interface that supports computer software and hardware under control of the software, which allows the operator to substitute for mouse, keyboard, or other computer entries that would normally be made by the hands of the operator. The foot control and interface of the present invention allows for the operation of the computer and feedback from the software and any hardware controlled by the software utilizing the operator's feet, freeing the operator's hands to perform other tasks. This may be a particular advantage in music recording and editing, as the user's hands would be entirely occupied with the playing of a musical instrument, such as a guitar, or operating another device with the user's hands.

An embodiment may include some or all of the following components:

Record transport function controller and bi-directional feedback indicator

Return to start function controller and bi-directional feedback indicator

Reverse function controller and bi-directional feedback indicator

Forward transport function controller and bi-directional feedback indicator

Play/Stop transport function controller and bi-directional feedback indicator

Loop transport function controller and bi-directional feedback indicator

Assignment of future, or ‘soft’ functions to switches and controllers

Foot controlled function controllers for “previous” and “next”

Foot controlled assignable function controllers #1, #2, #3, #4 and #5

Assignable colored bi-directional feedback indicators for each assignable function controller

An embodiment of the present invention is a device that allows a user to control a navigation function of an electronic system. The navigation function may be a transport function, such as play/stop, loop etc., and the electronic system may have a navigation status related to the transport function, such as transport playing, or transport stopped. The electronic system may be a computer running a program to record audio, such as (but not limited to) Garageband™ for Apple Macintosh®, or may be any device that processes streaming data. The streaming data may be analog or digital data transferred at a steady rate, and may come from devices including but not limited to an instrument, a camera, a telephone, or another electronic system.

In an embodiment, a switch includes a visual indicator that transitions between two states, such as (but not limited to) a light that transitions between a lighted state and unlighted state. The visual indicator may have an icon identifying the associated transport function, such as a play-symbol (a triangle pointing to the right), which is lighted when the transport is playing, and unlighted when the transport is stopped. A communication interface may provide bi-directional communication between the embodiment and the electronic device, including (but not limited to) universal serial bus (USB), Musical Instrument Digital Interface (MIDI), Ethernet, including Ethernet audio video bridging (Ethernet AVB), or other wired or wireless communication equipment.

In an embodiment, when the user operates the switch (for example, by stepping on a button), the embodiment sends a message for the associated navigation function to the electronic device, and the electronic device may attempt to perform an activity related to the navigation function. For example, stepping on the play/stop button may send a play/stop message or command, and the electronic device either stops (if playing) or start playing (if stopped) an audio or other data track. When the status of the navigation function changes (when the audio starts or stops), the electronic sends a message or command to the embodiment, to indicate that the play/stop button should be lighted or unlighted. The navigation status may be changed in ways other than in response to messages from the embodiment, and the electronic device may report this to the embodiment. For example, someone might use a mouse to directly interface with the electronic device and click on the stop button. This provides visual feedback, allowing the user to monitor the navigation status of the electronic device for the function associated with the switch.

An embodiment may include an input to receive streaming data, and provide the streaming data to the electronic device over the communication interface. The embodiment may receive a feedback streaming data, and output the feedback streaming data to speakers, amplifiers, headphones, monitors, or other equipment for streaming media. The feedback streaming data might include the first streaming data, modified by the electronic system, or it might include playback of previously recorded materials.

In an embodiment, the electronic device may have a data setting or status that indicates how the electronic system should modify, store, or otherwise data process the streaming data, such as (but not limited to) adding effects like sustain or fuzz, and the electronic device may associate a color with the effect, such as red for fuzz. The user may then use another embodiment of a switch with visual indicator to control and monitor the data setting. This visual indicator may be adjacent the switch, rather than on it, and it may display different colors when lighted so as to generally match the colors used in the electronic device. For example, the switch to control the fuzz effect will have a light above the switch that is either lighted red when fuzz is on and unlighted (or black) when fuzz is off. The electronic device may modify the data setting or associated color for the data setting, and will provide a message to the embodiment to indicate the proper color for the associated switch.

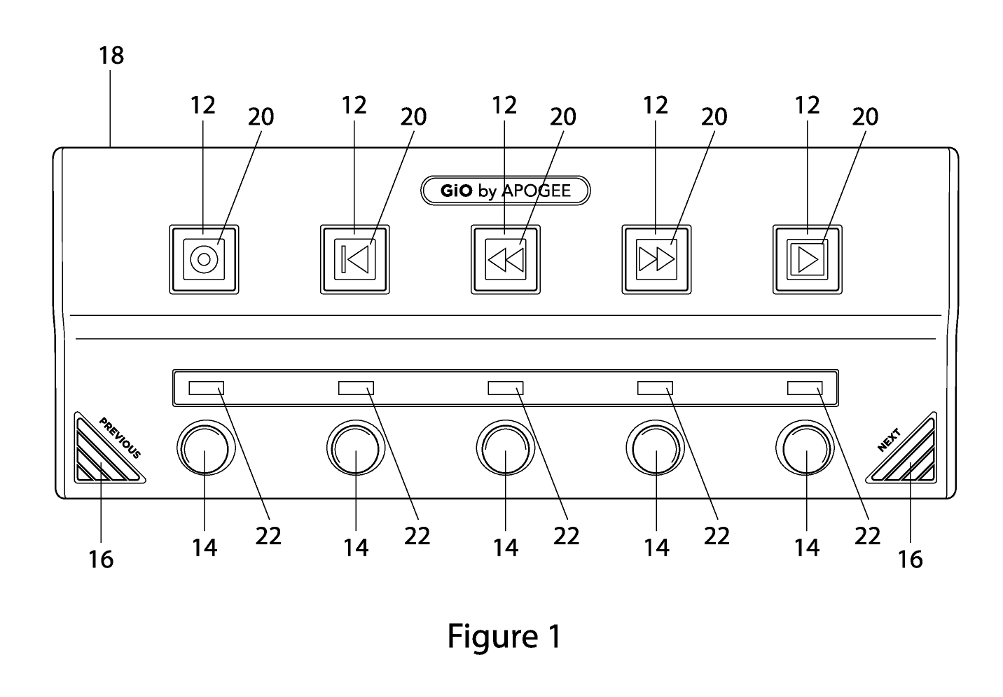

As depicted in FIG. 1, an embodiment of the present invention 10 may include five transport switches 12, five effects, “stompbox,” or other soft-assigned function (non-transport) switches 14, two navigation switches 16 (e.g. for previous or next bank of soft-assigned functions), and a housing 18. Each transport switch 12 includes a lighted icon 20 including a graphic indicating the transport function to be performed, namely, record, return to start, reverse, forward, and play/stop. Each non-transport switch 14 includes a colored light 22 associated with the switch. In an embodiment, the colors of the colored lights 22 change to generally match the colors displayed on a computer that provides corresponding musical effects, including but not limited to colors for sustain, delay, fuzz, overdrive, or flanger. The non-transport switches and previous/next switches may select preset effects for an electric guitar track in a software application or other device including but not limited to Garageband™, Reason™ and other applications.

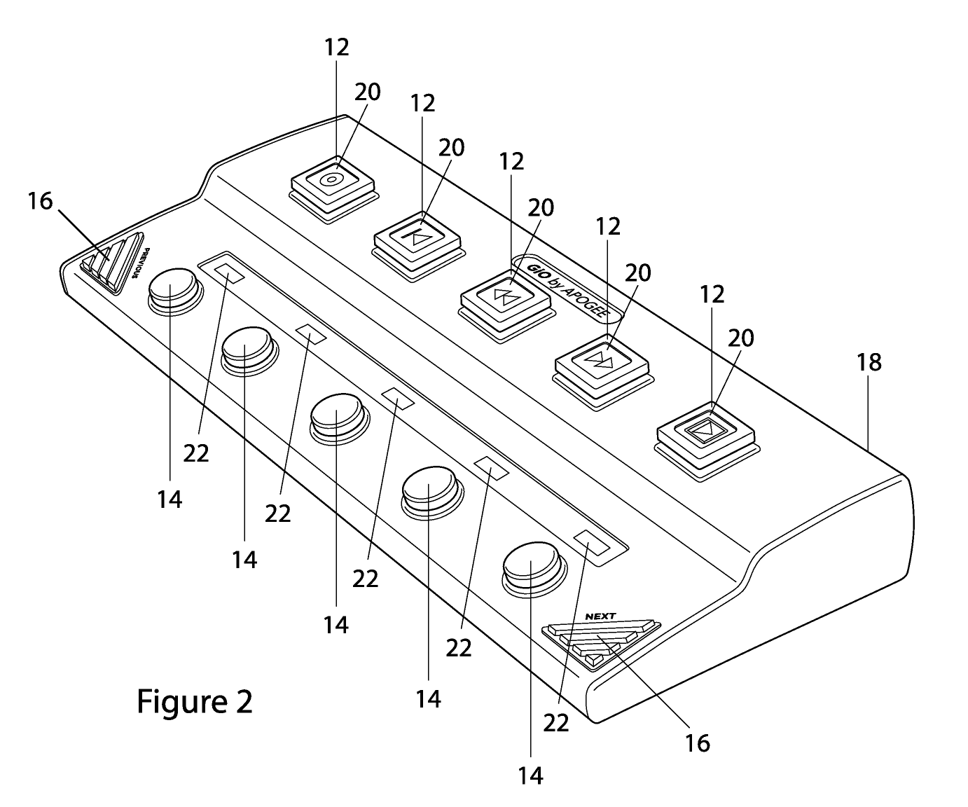

FIG. 2 depicts a perspective view of the embodiment of FIG. 1. The user plays an instrument such as a guitar (not shown in FIG. 2) using his or her hands, and uses his or her feet 22 to step on the switches 12, 14, thereby providing for unrestricted operation of the musical instrument while using the feet 22 to control the transport and other functions of the streaming medium (such as a digital audio recorder).

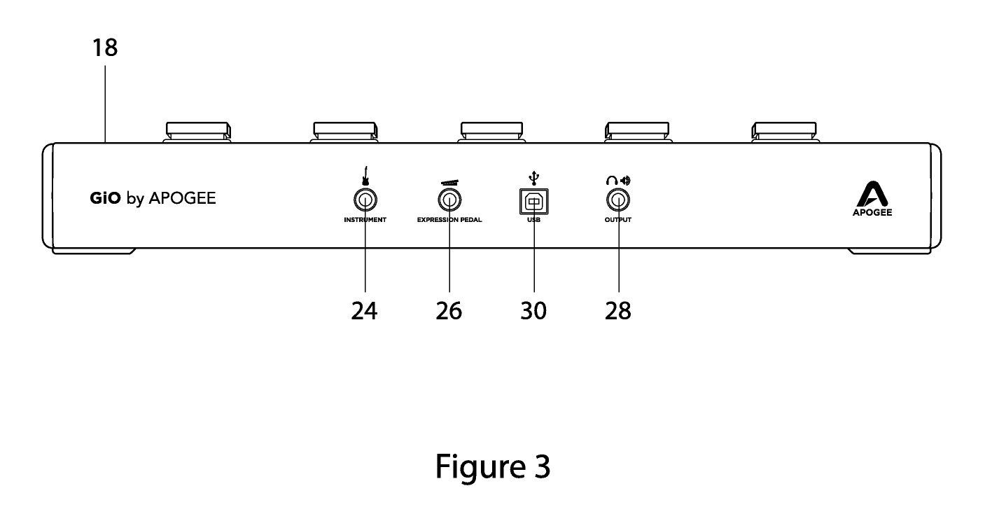

FIG. 3 depicts the back of an embodiment of the present invention 10. This includes a housing 18 with an instrument input 24, an expression pedal input 26, a headphone/speaker output 28, and a computer or other peripheral connection 30, including but not limited to a universal serial bus (USB) port 30. The expression pedal allows for a control input to further control properties of the music being recorded onto the streaming medium.

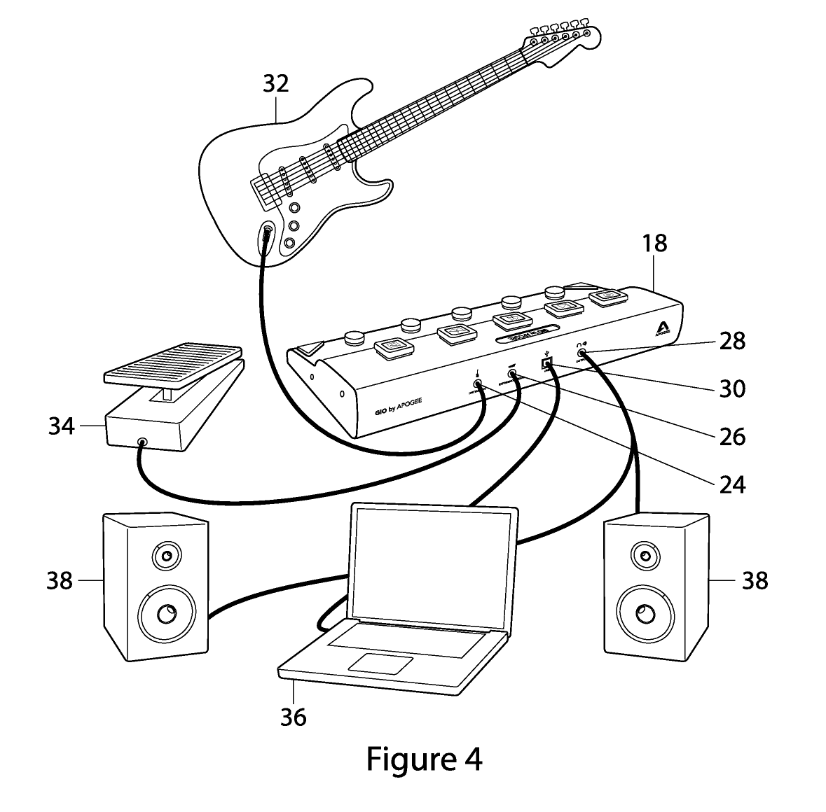

FIG. 4 depicts an embodiment of the present invention 10 with a guitar 32 (a musical instrument capable of outputting streaming media music), connected to the instrument input 24, a pedal 34 connected to the expression pedal input 26, a computer 36 connect to a peripheral connection 30, and a headphone/speaker output 28 connected to speakers 38.

In an embodiment of the invention, the computer may be an Apple® computer or other peripheral running programs such as GarageBand™, QuickTime™, or other programs to edit music, video, or other streaming data. In an embodiment adapted to use GarageBand™, there are five transport switches for record, return to start, reverse, forward, and play/stop. An embodiment for QuickTime™ includes four buttons for return to start, reverse, play/stop, and forward. Embodiments utilize a computer running a computer editor program that is appropriate for creating music, video, or other streaming media, including but not limited to an Apple Macintosh® workstation.

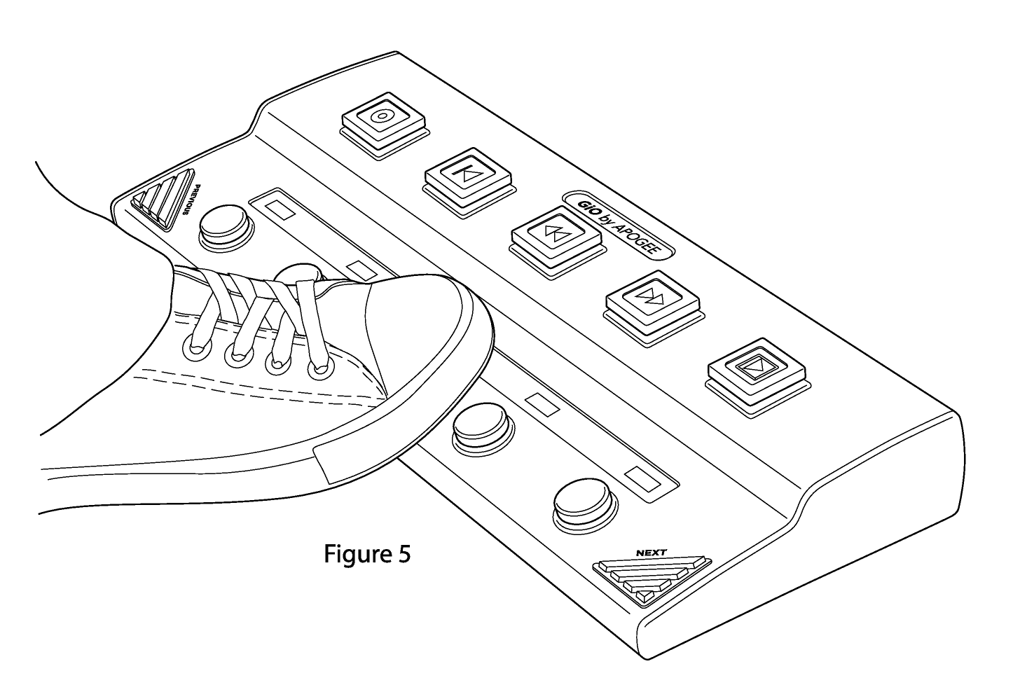

FIG. 5 depicts an embodiment of the present invention being utilized by a foot of a user.

I claim:

1. A device for a user to control a navigation function of an electronic system, the electronic system having a navigation status associated with the navigation function, the device comprising:
a switch adapted to be operated by the user;
a visual indicator on the switch, transitionable between a first state and a second state;
a symbol on the visual indicator to identify the navigation function;
a communication interface to the electronic system;
wherein the device utilizes the communication interface to send a first message related to the navigation function to the electronic system in response to the user operating the switch;
the device utilizes the communication interface to receive a second message related to the navigation status from the electronic system; and
the visual indicator transitions between the first state, and the second state to indicate the navigation status.

2. The device of claim 1, wherein the switch is adapted to be operated by a foot of the user.

3. The device of claim 1, wherein the switch is a button that transmits a tactile sensation to the user when the button is depressed by the user.

4. The device of claim 1, wherein the device provides an audible feedback when the switch is operated.

5. The device of claim 1, wherein the visual indicator has a light that is lighted to illuminate the symbol when the visual indicator is in the first state, and unlighted when the visual indicator is in the second state.

6. The device of claim 1, further comprising:
an insert having the symbol;
wherein the switch releasably retains the insert, thereby allowing the insert to identify the navigation function.

7. The device of claim 1, the electronic device having a plurality of navigation functions, each said navigation function having an associated navigation status, the device further comprising:
a plurality of switches adapted to be operated by the user, each said switch having a visual indicator transitionable between first and second states and a symbol to identify one of the plurality of navigation functions;
wherein, the device utilizes the communication interface to send a first message to the electronic device related to the navigation function identified on the symbol of said switch in response to said switch being operated by the user;
the device utilizes the communication interface to receive a second message related to the navigation status associated with said identified navigation function from the electronic system; and
the visual indicator of said switch transitions between the first state and the second state to indicate said associated navigation status.

8. The device of claim 1, further comprising:
an input interface to receive streaming data;
wherein the device utilizes the input interface to receive the streaming data; and
the device utilizes the communication interface to provide the streaming data to the electronic system.

9. The device of claim 1, further comprising:
an input interface to receive data from a data generator operable by a hand of the user;
wherein the switch is adapted to be operated by a foot of the user.

10. The device of claim 1, wherein the navigation function is a transport function for a streaming medium.

11. The device of claim 1, further comprising:
an output interface to provide streaming data to a streaming medium.

12. A device for a user to provide streaming data to an electronic system, the electronic system having a data setting associated with a color, the device comprising:
a switch adapted to be operated by the user;
a visual indicator associated with the switch, to display a changeable color;
a communication interface to the electronic system;
an input interface to receive the streaming data;
wherein the device receives the streaming data from the input interface and utilizes the communication interface to provide the streaming data to the electronic system;
the device utilizes the communication interface to send a first message related to the data setting to the electronic system in response to the user operating the switch;
the device utilizes the communication interface to receive a second message related to the data setting from the electronic system; and
the visual indicator changes color to generally match the color with which the data setting associates.

13. The device of claim 12, wherein the data setting is associated with data processing to be performed upon the streaming data provided to the electronic system.

14. The device of claim 12, the electronic system having a plurality of data settings, each associated with a color, the device further comprising:
a plurality of switches adapted to be operated by the user, each said switch associated with a visual indicator to display a changeable color, each said switch associated with one of the plurality of data settings;
wherein, when each said switch is operated by the user, the device utilizes the communication interface to send a message to the electronic device related to the data setting with which the switch associates.

15. The device of claim 12, wherein the switch is a button adapted to be operated by the foot, and the visual indicator is a colored lamp adjacent the button.

16. The device of claim 12, the electronic system having a navigation function and a navigation status associated with the navigation function, the device further comprising:
a second switch adapted to be operated by the user;
a visual indicator on the second switch, transitionable between a first state and a second state;
a symbol on the visual indicator to identify the navigation function;
wherein the device utilizes the communication interface to send a third message related to the navigation function to the electronic system in response to the user operating the second switch;
the device utilizes the communication interface to receive a fourth message related to the navigation status from the electronic system; and
the visual indicator transitions between the first state and the second state to indicate the navigation status.

17. A method for remotely monitoring and navigating an electronic system, comprising:
providing a remote switch that indicates a navigation function and that transitions between a first state and a second state;
operating the switch;
in response to operating the switch, sending a first message related to the navigation function to the electronic system;
receiving a second message related to a navigation status of the navigation function from the electronic system; and
transitioning the switch the first state and the second state to indicate the navigation status.

18. The method of claim 17 further comprising:
receiving streaming data; and
transmitting the streaming data to the electronic device.

19. The method of claim 18 further comprising:
associating a color with a data setting related to a data processing of the streaming data;
providing a second switch associated with the data setting;
operating the second switch;
in response to operating the second switch, sending a third message related to the data setting to the electronic system;
performing the data processing on the streaming data transmitted to the electronic device;
receiving a fourth message related to the data setting from the electronic system; and
providing an indicator in association with the second switch having a color that generally matches the color associated with the data setting.

20. The method of claim 17, wherein the switch is adapted to be operated the foot of a user, further comprising:
providing tactile feedback to the foot when the switch is operated.
